(19) United States
(12) Patent Application Publication
(10) Pub. No.: US 2010/0086755 A1
(43) Pub. Date: Apr. 8, 2010

(54) OXYGEN BARRIER MULTILAYER STRUCTURE, AND MULTILAYER PACKAGING MATERIAL AND MULTILAYER CONTAINER USING SAME

(75) Inventors: Takehiko Sumi, Kanagawa (JP); Tetuaki Eguchi, Kanagawa (JP); Daisuke Yamazaki, Kanagawa (JP)

Correspondence Address: Vern Maine & Associates, 100 MAIN STREET, P O BOX 3445, NASHUA, NH, 03061-3445, US

(73) Assignee: KYORAKU CO., LTD., Tokyo (JP)

(21) Appl. No.: 12/067,057

(22) PCT Filed: Sep. 27, 2006
(86) PCT No.: PCT/JP2006/319210

§ 371 Date: Mar. 17, 2008

(30) Foreign Application Priority Data
Sep. 27, 2005 (JP) 2005-280995

(51) Int. Cl. B32B 27/08; B32B 7/02

(52) U.S. Cl. 428/213; 428/212

(57) ABSTRACT

An oxygen barrier multilayer material for containers is developed that selectively shields oxygen from the outside and also shields volatile substances by-produced by oxidation reaction. Provided are a selective oxygen absorbent multilayer structure produced by co-extrusion having an oxygen absorbing layer containing an oxygen absorbing resin composition, an inner barrier layer (A) and an outer barrier layer (C) arranged inside and outside the oxygen absorbing layer, in which the oxygen transmission rate of the outer barrier layer (C) is smaller than the oxygen transmission rate of the inner barrier layer (A), and a multilayer packaging material and a multilayer container, using the selective oxygen absorbent multilayer structure.

### TECHNICAL FIELD

The present invention relates to an oxygen barrier multilayer structure that is easy to handle without inactivating an oxygen absorption performance in a short period of time, has shielding properties against by-products along with an oxygen absorption function and has continuous gas barrier properties and oxygen absorption properties during storage in a state of a film or sheet in a multilayer structure such as a film or sheet having an oxygen absorbing resin composition for forming a packaging material or a container, and also relates to a multilayer packaging material and a multilayer container using the oxygen barrier multilayer structure.

### BACKGROUND ART

Since the development of ethylene-vinyl alcohol copolymers (EVOH) excellent in gas (oxygen, carbon dioxide gases) barrier properties, EVOHs are resins that have been widely utilized as gas barrier materials for packaging materials or containers, etc. for products that dislike oxygen in place of glass, metal or conventional plastic materials in the fields of foods, cosmetics, industrial chemicals, etc. EVOH has moisture absorption characteristics and its barrier properties are decreased after its moisture absorption. Therefore, usually, EVOH is covered with a hydrophobic thermoplastic resin such as a polyolefin resin or polyethylene resin for use, or is used as an intermediate layer or for a multilayer structure having thermoplastic resins as an inner layer and an outer layer.

EVOH is widely used for such as packaging materials by making use of its gas barrier properties. Although EVOH does not have action of absorbing oxygen, it does not completely shield oxygen, so that slight oxygen transmission is unavoidable. In addition to this permeated oxygen, in a container in which oxygen is already present during sealing or particularly in a food container frequently used by opening and closing its lid, the removal of oxygen newly coming therein during its opening and closing poses a problem mainly in food industries. As a result, packaging materials using gas barrier resins such as EVOH and resins having an oxygen absorption performance (oxygen absorbing resins) have been enthusiastically developed (e.g., see Patent Document 1).

An oxygen absorbing resin is composed of a comparatively unstable and readily oxidized oxidative resin. Specifically, oxidative resins include thermoplastic resins having a carbon-carbon double bond, and polyolefin resins (resins particularly having a tertiary carbon atom on their backbone). The oxidative resins are particularly readily oxidized in the presence of an oxidation catalyst, and are made to react with oxygen in air to exhibit an oxygen absorption performance (oxygen scavenging performance). As the oxygen catalysts, transition metals such as cobalt and their organic salts or inorganic acid salts are used as required. In addition, there are proposed, as other oxygen absorbing resins, a polyamide composition containing a polyamide (PA) and a PA reactive oxidizable polybutadiene or an oxidizable polyether, and a polyamide composition prepared by adding an oxidation promoting metal salt catalyst in the polyamide composition, as well as a multilayer product produced by arranging a thermoplastic resin layer on one side or both sides of an oxygen barrier polyamide layer comprising the polyamide composition (e.g., see Patent Document 2).

However, an oxygen absorbing resin, after absorbing a certain amount of oxygen, loses its oxygen absorbent performance, and then does not have the effect of absorbing oxygen. In other words, this means that after reacting with a certain amount of oxygen, the oxidative resin does not come to react with oxygen or rarely reacts with oxygen.

Because of this, a multilayer structure produced by laminating an oxygen absorption layer having an oxygen absorbing resin to a barrier layer made of a gas barrier resin is proposed for controlling the amount or the rate of oxygen reaching the oxygen absorption layer to maintain the oxygen absorbent performance for a desired period of time (e.g., see Patent Document 3). In addition, structures produced by sandwiching an oxygen absorption layer with a barrier layer are proposed for shielding oxygen reaching the oxygen absorption layer from the inside and outside of a container to maintain the oxygen absorbent performance for a long period of time, even when a container is produced and then filled with contents and sealed, which is carried out in air (e.g., see Patent Documents 4 and 5).

However, if the barrier layer is simply thickened for decreasing the amount of oxygen reaching the oxygen absorption layer, not only the cost of the multilayer structure is increased, but a packaging material or container comprising the multilayer structure becomes rigid. In particular, in the case of a soft packaging material such as a bag, not only its performance cannot be sufficiently exhibited, but there is the problem of lowering molding properties in a step of producing a bag.

Still furthermore, the oxygen absorbing resin generates by-products along with oxidation reaction of the resin in a step of absorbing oxygen. The by-products are generally volatile substances and by-products generated in the oxygen absorbing layer are liable to permeate other layers of the multilayer structure. As such, for suppression of the transmission of by-products, proposed is a multilayer container constituted such that a layer made of resins such as EVOH is arranged as a gas barrier layer shielding the by-products in between the oxygen absorbing layer and the inner layer (e.g., see Patent Document 6). However, materials of the gas barrier layer also have barrier properties to oxygen, and thus shield the oxygen within the container from reaching the oxygen absorbing layer and cannot tend to exhibit a suitable oxygen absorbent performance.

### Patent Document 1: Japanese Patent Application Laid-Open No. 2001-106920

Patent Document 2: Published Japanese translation of PCT application No. 2003-531929

### Patent Document 3: Japanese Patent Application Laid-Open No. 5-115776

Patent Document 4: Published Japanese translation of PCT application No. 11-514385

### Patent Document 5: Japanese Patent Application Laid-Open No. 2002-240813

### Patent Document 6: Japanese Patent Application Laid-Open No. 6-115569

### DISCLOSURE OF THE INVENTION

### Problems to be Solved by the Invention

Now, an object of the present invention is to develop a multilayer structure that is easy to handle without inactivating an oxygen absorption performance and has shielding properties against by-products along with gas barrier properties and oxygen absorption properties during storage in a state of a film or sheet in a multilayer structure such as a film or sheet having an oxygen absorbing resin composition for forming a packaging material or container; and a multilayer packaging material and a multilayer container comprising the multilayer structure, which are excellent in self stability for contents, suitably shielding oxygen from the outside without substantial oxygen transmission for a certain period particularly even when subjected to high humidity conditions by retorting or the like.

The present inventors have diligently studied for solving the above problems and found that a multilayer structure can be obtained in such a manner that an inner barrier layer and an outer barrier layer including a gas barrier resin such as ethylene-vinyl alcohol (EVOH) or polymetaxylylene adipamido (MX-nylon) are arranged inside and outside an oxygen absorbing layer made of an oxygen absorbing resin, and are laminated in a specific film thickness ratio such that the oxygen transmission rate of the outer barrier layer becomes small as compared with that of the outer barrier layer under high humidity conditions (30° C.-80% RH). The multilayer structure can suitably shield oxygen in air from permeating an oxygen barrier multilayer structure from the outside and reaching contents present inside, and maintain high oxygen barrier properties even when the oxygen absorption performance is inactivated. The multilayer structure can also selectively shield the oxygen reaching the oxygen absorbing layer against oxygen in air inside and outside the container so as to make the oxygen reaching the inside of the container substantially zero for a certain period of time, and also reduce the oxygen concentration within the container. The present invention has been done on the basis of such findings.

### Means for Solving the Problems

In other words, the present invention provides an oxygen barrier multilayer structure constituted by the constructions described below, and a multilayer packaging material and a multilayer container using a multilayer film, a multilayer sheet, or the like.

A multilayer structure according to the present invention has an oxygen absorbing layer (B) including a thermoplastic resin, and an inner barrier layer (A) and an outer barrier layer (C) respectively arranged inside and outside the oxygen absorbing layer (B), wherein the inner barrier layer (A) is constituted such that the oxygen transmission rate (cc/m²·day·atm) is larger than the oxygen transmission rate (cc/m²·day·atm) of the outer barrier layer (C) under conditions of 30° C.-80% RH. In particular, the oxygen transmission rates of the inner barrier layer (A) and the outer barrier layer (C) are respectively 15 (cc/m²·day·atm) or less under conditions of 30° C.-80%, and the ratio of the oxygen transmission rates between the inner barrier layer (A) and the outer barrier layer (C) are from 1:0.5 to 1:0.01.

Moreover, the film thickness ratio of the inner barrier layer (A) relative to the total film thickness of a co-extruded multilayer structure is characterized by being constituted so as to be smaller than the film thickness ratio of the outer barrier layer (C). In particular, the film thickness ratio of the inner barrier layer (A) is characterized by being ½ or less the film thickness ratio of the outer barrier layer (C), or the film thickness of the inner barrier layer (A) is characterized by being 5 p.m.

In addition, the oxygen absorbing layer (B) is characterized by being arranged between the inner barrier layer (A) and the outer barrier layer (C) without using an adhesive, and the interlayer adhesion strength (JIS Z0238) between the inner barrier layer (A) and the outer barrier layer (C), next to the oxygen absorbing layer (B), is characterized by being 10 g/15 mm width or more.

### EFFECTS OF THE INVENTION

An oxygen barrier multilayer structure of the present invention has the above (A) to (C) layers and in particular the film thickness ratios of the inner barrier layer (A), the oxygen absorbing layer (B) and the outer barrier layer (C) are specified to achieve the excellent characteristics described below.

1) At least the (A) to (C) layers of the multilayer structure are co-extruded and the film thickness ratio of the (A) layer is smaller than the film thickness ratio of the (C) layer (in particular, the film thickness ratio of the (A) layer is a half or less the film thickness ratio of the (C) layer) to enable the oxygen transmission rate (cc/m²·day·atm) under conditions of 30° C.-80% RH to be smaller than that of the (A) layer. Under high humidity conditions also, oxygen in air is selectively shielded from reaching the (B) layer and a small amount of oxygen not shielded and permeated is absorbed by the (B) layer, whereby oxygen can be prevented from passing through the oxygen barrier multilayer structure and reaching contents inside. Furthermore, even in the case where the inner barrier layer (A) and the outer barrier layer (C) are arranged inside and outside the oxygen absorbing layer (B), the oxygen transmission rate of the inner barrier layer (A) is made to be from 2 to 100 times the oxygen transmission rate of the outer barrier layer (C), with the result that the oxygen transmission from inside can be selectively promoted and the oxygen concentration within the container can be reduced. In general, the oxygen transmission rate does not exhibit a simple proportional relation to the thickness of a film. When the thickness is smaller than a certain thickness, the oxygen transmission rate is rapidly increased. In particular, the thickness of the range of less than 5 μm provides suitable oxygen transmission for decreasing the oxygen concentration within in a container.

2) The oxygen transmission rates of the inner barrier layer (A) and the outer barrier layer (C) are 15 (cc/m²·day·atm) or less, which makes it possible to keep the shielding properties of by-products generated by the oxygen absorbing layer (B) and also suitably prevent inactivation of the oxygen absorption performance of the oxygen absorbing layer (B) prior to using as a package material or container.

3) The inner barrier layer (A) and the outer barrier layer (C) of the multilayer structure are constituted by an aromatic polyamide such as an ethylene-vinyl alcohol copolymer such as ethylene-vinyl alcohol (EVOH) or polymetaxylylene adipamido (MX-nylon), and also the oxygen absorbing layer (B) is constituted by a reaction product of a polyamide and an oxidizable polydiene. With this, it is possible to make the oxygen reaching the inside of the container substantially zero for a certain period of time, and also obtain a desirable interlayer adhesion strength (10 g/15 mm width or more) without locating an adhesive layer between the (A) and (C) and (D) layers, whereby the layer structure is simplified.

### BEST MODE FOR CARRYING OUT THE INVENTION

The present invention will be described in detail hereinafter. A thermoplastic resin constituting the (A) and (C) layers has oxygen barrier properties and the (A) and (C) layers are constituted so as to be smaller in the oxygen transmission rate than the (B) layer after the inactivation of the oxygen absorption performance. Preferably, a resin having an oxygen transmission rate of 10 (cc·20 μm/m²·day·atm) or less, preferably 1.0 (cc·20 μm/m²·day·atm) or less is suitably used. In addition, a thermoplastic resin constituting the (A) and (C) layers has a melting point of 180° C. or higher, preferably 185° C. or higher, and more preferably 190° C. or higher. As the above thermoplastic resin is suitably used an ethylene-vinyl alcohol copolymer (EVOH) or an aromatic polyamide, etc. In particular, EVOH is suitable and in general used is a resin in which an ethylene-vinyl acetate copolymer having an ethylene content of 60 mol % or less is saponified to its saponification number of 90% or more.

The adjustment of the oxygen transmission rates of the (A) and (C) layers can lead to a selective shielding of the oxygen from outside air outward reaching the oxygen absorbing layer as compared with the oxygen reaching the oxygen absorbing layer from the inside of a container inward, make the oxygen reaching the inside of the container substantially zero for a certain period of time, and also reduce the oxygen concentration within the container. In other words, co-extrusion and lamination are implemented with a specified film thickness ratio in such a manner that the oxygen transmission rate of the outer barrier layer becomes small as compared with that of the inner barrier layer, to enable effectively absorption of the oxygen within the container.

The sum of the film thickness ratios of the (A) and (C) layers is preferably 50% or less relative to the total film thickness of the multilayer structure formed by co-extrusion from the viewpoint of processability to a container or packaging material. When the film thickness ratio of the (A) layer becomes ½ or less the film thickness ratio of the (C) layer, it is possible to shield oxygen from outside air and obtain a relative ratio of the oxygen transmission rate enough to reduce the oxygen concentration within the container.

As a thermoplastic resin making up the (B) layer of the present invention, a well-known oxygen absorbing resin can be used as long as the oxygen absorbing resin contains a readily-oxidized oxidative resin that reacts with oxygen in air to exhibit an oxygen absorption performance (oxygen scavenging performance) such as a thermoplastic resin having a carbon-carbon double bond, a polyolefin resin (particularly a resin having a tertiary carbon atom) or polymetaxylylene adipamido (MX-nylon) or a mixture thereof. In particular, a resin containing as a primary component a polymer having an unsaturated bond derived from a conjugated diene is preferred from the viewpoints of mold processability and oxygen absorption ability. Furthermore, a transition metal catalyst is preferably added thereto for the purpose of the promotion of oxidation of an oxygen absorbing resin.

In particular, the thermoplastic resins constituting the (B) layer suitably include resins comprising reaction products of polyamides with polyamide-reactive oxidizable polydienes or with oxidizable polyether and transition metal salts. An oxidizable polydiene or polyether is made to react with a polyamide, and its polydiene or polyether is preferably used in an acid modified form, includes an epoxy group or an anhydrous functional group and is made to react with a carboxyl group or an amino terminal group or further with an amide group on the polyamide backbone.

The above polyamides are suitable so long as the polyamides are polymers having an amide group and include, in addition to polymers obtained by dehydration condensation reaction of a carboxylic acid with an amine, polymers having an amide bond obtained by reaction of a carboxylic acid with isocyanate. Specific examples thereof include aliphatic polyamide single polymers such as polycaproamide (nylon-6), polyundecaneamide (nylon-11), polylaurolactam (nylon-12), polyhexamethylene adipamide (nylon-6,6) and polyhexamethylene sebacamide (nylon-6,10); aliphatic polyamide copolymers such as caprolactam/laurolactam copolymer (nylon-6/12), caprolactam/aminoundecanoic copolymer (6/11), caprolactam/w-aminononanoic copolymers (nylon-6/9), caprolactam/hexamethylene adipamide copolymer (nylon-6/6,6), and caprolactam/hexamethylene adipamide/hexamethylene sebacamide copolymer (nylon-6/6,6/6,10); and aromatic polyamides such as polymetaxylylene adipamido (MX-nylon) and hexamethylene terephthalamide/hexamethylene isophthalamide copolymer (nylon-6T/6I), or mixtures thereof

In particular, blends of amorphous polyamides or crystalline polyamides and amorphous polyamide are appropriate. Herein, amorphous polyamides refer to a group of polyamide resins in which the crystal fusion heat quantity determined by the differential scanning calorimeter (DSC) is 1 cal/g or less and crystallization of its polymer rarely occurs or the crystallization speed is very small. Oxidizable polydienes include, for example, epoxy functionalized polybutadienes, epoxy functionalized polybutadienes, epoxy functionalized polyisoprenes, maleic anhydride graft or copolymerized polybutadienes, and maleic anhydride graft or copolymerized polyisoprenes.

In addition, oxidizable polyethers include, for example, amines, epoxy or anhydrous functional polypropylene oxides, polybutylene oxides, and polystylene oxides. Moreover, a thermoplastic resin constituting the (B) layer has added thereto a transition metal salt as an oxidation catalyst in an amount of 5000 ppm or less in terms of metal atom weight. The transition metal salts include inorganic, organic or complex salts of cobalt, iron, nickel, and further copper, titanium, chromium, manganese, ruthenium, etc. In particular, carboxylate salts, sulfonate salts, and the like are suitable, and examples thereof include acetate salts, stearate salts, propionate salts, hexanoate salts, octanoate salts, decanoate salts, and stearate salts.

Here, to the (A), (B) and (C) layers may be added, as appropriate, a variety of well-known additives, coloring agents, heat resistant/weather resistant agents, adhesives and further as base resins other thermoplastic resins such as ethylene-vinyl alcohol copolymers, polyamide resins, polyester resins and polyolefin resins within the range of not loosing the achievement of the object.

Furthermore, a polyolefin resin is preferably used as a thermoplastic resin constituting a heat seal layer and a moisture resistant resin. The polyolefin resins that can be used as appropriate include well-known resins such as low density polyethylene, straight chain low density polyethylene, super low density polyethylene, straight chain super low density polyethylene, high density polyethylene, polypropylene, ethylene-propylene copolymers, and mixtures thereof. Still furthermore, the adhesive resins that can be suitably used include olefin copolymers having a carboxyl group and epoxy, polyurethane, or polyester curing resins. Of these, ethylene-acrylic acid copolymers, ethylene-methacrylic acid copolymers, maleic anhydride modified polyethylene and the like are appropriate for adhesion with a polyolefin resin layer.

In addition, as multilayer structures formed by co-extrusion in the present invention, the following layer configurations are particularly appropriate.

Five-layer structure: In order from the inside layer, heat seal layer/adhesive layer/inner barrier layer/oxygen absorbing layer/outer barrier layer

Seven-layer structure: In order from the inside layer, heat seal layer/adhesive layer/inner barrier layer/oxygen absorbing layer/outer barrier layer/adhesive layer/humidity resistant resin layer

Moreover, a repro layer constituted by a recycle resin can be further added as appropriate to the multilayer structures of the above constructions. Or separately, as required, to the outermost layer of an oxygen barrier multilayer structure, at least one resin layer selected from the group consisting of a polyethylene terephthalate (PET) resin layer, a polyamide (PA) resin layer, a polybutylene terephthalate (PEN) resin layer, a resin layer comprising polyvinyl alcohol and polyacrylic acid, and an inorganic vapor-deposited resin layer can be laminated by dry lamination or wet lamination. Utilization of, as recycle resins, mill ends generated during molding and processing that are crushed as scrapped resins is important from the viewpoints of not only reduction of production costs, but effective utilization of resources.

A multilayer packaging material and a multilayer container constituted by the multilayer structure according to the present invention can prevent the oxidation or deterioration of their contents by oxygen in air and elongate their shelf lives. Examples of the contents include foods such as mayonnaise, sauces, ketchup, dressings and food oils and further drinks, cosmetics, and industrial chemicals.

Next, the present invention will be described in further detail by way of examples.

### EXAMPLES

A multilayer packaging material comprising a multilayer structure of each example was formed, and the performance of this multilayer packaging material was evaluated according to the following measurement methods and criteria.

### 1) Oxygen Transmission Rate

A bag was made from a multilayer packaging material and was measured by an oxygen transmission rate measuring apparatus (Ox-Tran 10/50, available from MOCON Inc.) under high humidity conditions of 30° C.-80% RH. Further, a special solution that changes the color of contents in a packaging material from white to blue when oxygen comes in the packaging material was filled therein to evaluate in time lapse the oxygen barrier properties under boiling sterilization conditions (95° C.×30 min) and high humidity conditions. In addition, the oxygen transmission rate of each layer was calculated from the oxygen transmission rate (cc·20 μm/m²·day·atm) and the film thickness (μm) of a resin composition constituting each of the layers, or alternatively a film having the same film thickness was produced and determined

### 2) Transmission Mount of By-Products (Shielding Properties)

Aldehyde compounds generated in a multilayer container in a time lapse of 365 days under high humidity conditions of 30° C.-80% RH were determined by chromatography.

### 3) Interlayer Adhesion Properties

The interlayer adhesion strength between the inner and outer barrier layers of the oxygen absorbing layer of a multilayer structure co-extruded was evaluated in accordance with JIS Z0238.

### Example 1

A co-extruded multilayer film of five-layer structure of, in order from the inside layer, heat seal layer/adhesive layer/inner barrier layer (A)/oxygen absorbing layer (B)/outer barrier layer (C), was fabricated using the resins described in a) to e) below.
a) Heat seal layer: Polypropylene resin
b) Inner barrier layer: MXD6 nylon, the oxygen transmission rate of which was 10 (cc·20 μm/m²·day·atm) at 30° C.-80% (trade name: MX NYLON6007, available from Mitsubishi Gas Chemical Company Inc.).
c) Outer barrier layer: An ethylene-vinyl alcohol copolymer having an ethylene content of 29 mol % and a saponification number of 99%, the oxygen transmission rate of which was 1.5 (cc·20 μm/m²·day·atm) at 30° C.-80% RH (trade name: Soarnol D2908, available from Nippon Synthetic Chemical Industry Co., Ltd.).
d) Oxygen absorbing layer: A thermoplastic resin having a carbon-carbon double bond derived from a conjugated diene
e) Adhesive layer: A modified polyolefin resin was used (trade name: MODIC L522, Mitsubishi Chemical Corp.).

The film thickness ratio of each layer was, in order from the inside layer, 44:8:8:25:15 (%), and a multilayer film produced by laminating a non-distraction film made of polyamide 6 on the above film of a total film thickness of 90 μm was deep drawn to obtain a packaging bag having an inner capacity of 100 cc. The oxygen transmission rate of the inner barrier layer under high humidity conditions of 30° C.-80% RH was 30 (cc/m²·day·atm). It was ensured that the packaging bag did not substantially exhibit oxygen transmission for a certain period of time and that the oxygen concentration within the packaging bag was lowered. The packaging bag indicated suitable flexibility upon using and also generated no peeling between layers.

### Example 2

A co-extruded multilayer film of seven-layer structure of, in order from the inside layer, heat seal layer/adhesive layer/inner barrier layer (A)/oxygen absorbing layer (B)/outer barrier layer (C)/adhesive layer/humidity resistant resin layer, was fabricated using the resins described in a) to d) below.
a) Heat seal layer and humidity resistant resin layer: A low density polypropylene resin
b) Inner barrier layer and outer barrier layer: An ethylene-vinyl alcohol copolymer having an ethylene content of 29 mol % and a saponification number of 99%, the oxygen transmission rate of which was 1.5 (cc·20 μm/m²·day·atm) at 30° C.-80% RH (trade name: Soarnol D2908, available from Nippon Synthetic Chemical Industry Co., Ltd.).
c) Oxygen absorbing layer: A reaction product (trade name: Aegis, available from Honeywell Corp.) of a polyamide (including an amorphous polyamide) and maleic anhydride modified polybutadiene. Note that an organic acid salt of cobalt was added to the reaction product as a transition metal catalyst.
d) Adhesive layer: A modified polyolefin resin was used (trade name: MODIC L522, Mitsubishi Chemical Corp.).

The film thickness ratio of each layer was, in order from the inside layer, 50:5:5:10:10:5:15 (%), and the above film was three-way sealed to obtain a packaging bag having an inner capacity of 200 cc. The total film thickness of the film was 100 μm. The oxygen transmission rate of the inner barrier layer was 8 (cc/m²·day·atm) and the oxygen transmission rate of the outer barrier layer was 3.5 (cc/m²·day·atm), under high humidity conditions of 30° C.-80% RH. It was ensured that the packaging bag did not substantially exhibit oxygen transmission for a certain period of time and that the oxygen concentration within the packaging bag was lowered. The packaging bag indicated suitable flexibility upon using and also generated no peeling between layers.

### Example 3

A co-extruded multilayer film of seven-layer structure of, in order from the inside layer, heat seal layer/adhesive layer/inner barrier layer (A)/oxygen absorbing layer (B)/outer barrier layer (C)/adhesive layer/humidity resistant resin layer, was fabricated using the resins described in Example 2.

A packaging bag was fabricated and evaluated as in Example 2 except that the film thickness ratio of each layer was, in order from the inside layer, 50:5:2:10:10:5:15 (%). The oxygen transmission rate of the inner barrier layer was 30 (cc/m²·day·atm) and the oxygen transmission rate of the outer barrier layer was 3.5 (cc/m²·day·atm), under high humidity conditions of 30° C.-80% RH. It was ensured that the packaging bag did not substantially exhibit oxygen transmission for a certain period of time and that the oxygen concentration within the packaging bag was made to be lower than the case in Example 2. The packaging bag indicated suitable flexibility upon using and also generated no peeling between layers.

### Comparative Example 1

A packaging bag was fabricated and evaluated as in Example 2 except that the inner barrier layer was not provided.

### Comparative Example 2

A packaging bag was fabricated and evaluated as in Example 2 except that the film thickness ratio of each layer was, in order from the inside layer, 50:5:10:10:10:5:15 (%).

The results of the testing measuring show the following.

1) Making the film thickness ratio of the (A) layer smaller than the film thickness ratio of the (C) layer (in particular, making the film thickness ratio of the (A) be ½ or less the film thickness ratio of the (C)) enables to suitably maintain shielding properties of by-products generated from the oxygen absorbing layer and also to selectively absorb the oxygen within a container so as to reduce the oxygen concentration within the container. Furthermore, it became possible to suitably prevent oxygen in air from reaching the inside of the contents by permeating through the oxygen barrier multilayer structure from the outside, and selectively shield oxygen in air outside to keep zero the oxygen concentration within the container. In other words, in the case where the film thickness of the inner barrier layer (A) is made to be ½ the film thickness of the outer barrier layer (C), theoretically the oxygen within the container selectively reaches the oxygen absorbing layer (B) until the oxygen concentration within the container becomes ½ the oxygen concentration in air, with the result of lowering the oxygen concentration within the container.

On the other hand, when the inner barrier layer was not arranged, shielding of by-products from reaching the inside of the container was decreased, leading to the quality degradation of the contents.

In addition, in the case where the film thickness of the inner barrier layer (A) was made equal to the film thickness of the outer barrier layer (C), a substantial decrease in the oxygen concentration within the container was not seen.

That is, the amount of oxygen reaching the oxygen absorbing layer (B) from the inside and the outside of the multilayer container is proportional to the oxygen concentration (the partial pressure of oxygen in air), and is decreased along with an increase in the barrier layer. Therefore, when the film thickness of the inner barrier layer (A) is made equal to the film thickness of the outer barrier layer (C), the oxygen within the container is difficult to reach the oxygen absorbing layer, whereby the percentage of oxygen reaching the oxygen absorbing layer (B) from the outer layer is relatively increased.

2) Provision of the (C) layer on the outside of the (B) layer of a multilayer structure led to appropriate shielding of the oxygen in air outside by the (C) layer, and slight oxygen permeated without shielding was absorbed by the (B) layer, whereby it was possible to suitably prevent permeation of oxygen in air through the oxygen barrier multilayer structure from the outside to reach the contents inside. That is, oxygen being present outside the multilayer container is shielded by the outer barrier layer (C), and oxygen not shielded is captured and absorbed by the oxygen absorbing layer (B). The amount of oxygen reaching the oxygen absorbing layer from the outside layer is inversely proportional to the film thickness of the outer barrier layer (C), and the amount of oxygen the oxygen absorbing layer (B) can absorb is proportional to the film thickness of the oxygen absorbing layer (B). For this reason, the film thicknesses of the (B) and (C) layers of the multilayer structure need to be a certain value or more for substantially making zero the oxygen permeation for a certain period of time.

3) Making the oxygen transmission rate of the outer barrier layer (C) smaller than that of the inner barrier layer (A) relative to the oxygen absorbing layer (B) of a multilayer structure under conditions of 30° C.-80% RH enabled the oxygen barrier properties to be maintained in high states even after the inactivation of the oxygen absorption performance. Moreover, the reduction of the amount of oxygen reaching the oxygen absorbing layer (B) by the outer barrier layer (C) makes it possible to decrease the film thickness of the oxygen absorbing layer (B). This enables the reduction of the amount of by-products generated from the oxygen absorbing layer and further the reduction of the film thickness of the outer barrier layer (A) for preventing the movement of the by-products into the container.

### INDUSTRIAL APPLICATION

As described in detail above, a multilayer structure constituted by an inner barrier layer, an oxygen absorbing layer and an outer barrier layer, having a specified ratio, of the present invention has oxygen barrier properties and oxygen absorption performance in well balance. Additionally, volatile substances generated by oxygen reaction in the oxygen absorbing layer are suitably shielded by the outer barrier layer. Thus, an oxygen barrier multilayer structure of the present invention is useful as packaging films and sheets in foods, drinks, cosmetics, industrial chemicals, etc.

1. An oxygen barrier multilayer structure comprising an oxygen absorbing layer comprising a thermoplastic resin, and an inner barrier layer and an outer barrier layer respectively arranged inside and outside the oxygen absorbing layer, wherein
the oxygen barrier multilayer structure is formed by co-extrusion so that the oxygen transmission rate (cc/m²·day·atm) of the outer barrier layer is smaller than the oxygen transmission rate (cc/m²·day·atm) of the inner barrier layer under conditions of 30° C.-80% RH.

2. An oxygen barrier multilayer structure comprising an oxygen absorbing layer comprising a thermoplastic resin, and an inner barrier layer and an outer barrier layer respectively arranged inside and outside the oxygen absorbing layer, wherein
the oxygen barrier multilayer structure is formed by co-extrusion so that the film thickness ratio of the inner barrier layer is smaller than the film thickness ratio of the outer barrier layer.

3. The oxygen barrier multilayer structure according to claim 1, wherein
the oxygen transmission rates of the inner barrier layer and the outer barrier layer are 15 (cc/m²·day·atm) or less under conditions of 30° C.-80%, and the ratio of the oxygen transmission rates between the inner barrier layer and the outer barrier layer is from 1:0.5 to 1:0.01.

4. The oxygen barrier multilayer structure according to claim 1, wherein
the film thickness ratio of the inner barrier layer is ½ or less the film thickness ratio of the outer barrier layer.

5. The oxygen barrier multilayer structure according to claim 1, wherein
the film thickness of the inner barrier layer is less than 5 μm.

6. The oxygen barrier multilayer structure according to claim 1, wherein
the oxygen absorbing layer is arranged between the inner barrier layer and the outer barrier layer without using an adhesive, and
the interlayer adhesion strength (JIS Z0238) between the inner barrier layer and the outer barrier layer, next to the oxygen absorbing layer, is 10 g/15 mm width or more.

7. The oxygen barrier multilayer structure according to claim 1, wherein
the inner barrier layer or the outer barrier layer comprise a resin selected from aromatic polyamides or ethylene-vinyl alcohol copolymers.

8. The oxygen barrier multilayer structure according to claim 1, wherein
the oxygen absorbing layer comprises a transition metal salt and a reaction product of a polyamide and an oxidizable polydien.

9. The oxygen barrier multilayer structure according to claim 1, wherein
the oxygen barrier multilayer structure is formed by co-extruding and laminating, in order from the inside, heat seal layer/adhesive layer/inner barrier layer/oxygen absorbing layer/outer barrier layer.

10. The oxygen barrier multilayer structure according to claim 1, wherein
the oxygen barrier multilayer structure is formed by co-extruding and laminating, in order from the inside, heat seal layer/adhesive layer/inner barrier layer/oxygen absorbing layer/outer barrier layer/adhesive layer/humidity resistant resin layer.

11. The oxygen barrier multilayer structure according to claim 1, wherein
at least one resin layer selected from the group consisting of a polyethylene terephthalate (PET) resin layer, a polyamide (PA) resin layer, a polybutylene terephthalate (PEN) resin layer, a resin layer comprising polyvinyl alcohol and polyacrylic acid, and an inorganic vapor-deposited resin layer is laminated by dry lamination or wet lamination to the outermost layer of the oxygen barrier multilayer structure formed by the co-extrusion.

12. A multilayer packaging material, wherein
a film is used that comprises any of the oxygen barrier multilayer structures according to claims 1.

13. The multilayer packaging material according to claim 10, wherein
the innermost layers of films constituted by an oxygen barrier multilayer structure are made next to each other and made heat fused.

14. A multilayer container, wherein
a sheet is used that comprises any of the oxygen barrier multilayer structures according to claims 1.

15. The multilayer container according to claim 12, wherein
a sheet comprising the oxygen barrier multilayer structure is vacuum or air-pressure formed.

16. The oxygen barrier multilayer structure according to claim 2, wherein
the oxygen transmission rates of the inner barrier layer and the outer barrier layer are 15 (cc/m²·day·atm) or less under conditions of 30° C.-80%, and the ratio of the oxygen transmission rates between the inner barrier layer and the outer barrier layer is from 1:0.5 to 1:0.01.

17. The oxygen barrier multilayer structure according to claim 2, wherein
the film thickness ratio of the inner barrier layer is ½ or less the film thickness ratio of the outer barrier layer.

18. The oxygen barrier multilayer structure according to claim 2, wherein
the film thickness of the inner barrier layer is less than 5 μm.

19. The oxygen barrier multilayer structure according to claim 2, wherein
the oxygen absorbing layer is arranged between the inner barrier layer and the outer barrier layer without using an adhesive, and
the interlayer adhesion strength (JIS Z0238) between the inner barrier layer and the outer barrier layer (C), next to the oxygen absorbing layer (B), is 10 g/15 mm width or more.

20. The oxygen barrier multilayer structure according to claim 2, wherein
the inner barrier layer or the outer barrier layer comprise a resin selected from aromatic polyamides or ethylene-vinyl alcohol copolymers.

21. The oxygen barrier multilayer structure according to claim 2, wherein
the oxygen absorbing layer comprises a transition metal salt and a reaction product of a polyamide and an oxidizable polydien.

22. The oxygen barrier multilayer structure according to claim 2, wherein
the oxygen barrier multilayer structure is formed by co-extruding and laminating, in order from the inside, heat seal layer/adhesive layer/inner barrier layer (A)/oxygen absorbing layer (B)/outer barrier layer (C)/adhesive layer/humidity resistant resin layer.

23. The oxygen barrier multilayer structure according to claim 2, wherein
at least one resin layer selected from the group consisting of a polyethylene terephthalate (PET) resin layer, a polyamide (PA) resin layer, a polybutylene terephthalate (PEN) resin layer, a resin layer comprising polyvinyl alcohol and polyacrylic acid, and an inorganic vapor-deposited resin layer is laminated by dry lamination or wet lamination to the outermost layer of the oxygen barrier multilayer structure formed by the co-extrusion.

24. A multilayer packaging material, wherein
a film is used that comprises the oxygen barrier multilayer structure according to claims 2.

25. The multilayer packaging material according to claim 22, wherein
the innermost layers of films constituted by an oxygen barrier multilayer structure are made next to each other and made heat fused.

26. A multilayer container, wherein
a sheet is used that comprises the oxygen barrier multilayer structure according to claim 2.

27. The multilayer container according to claim 24, wherein
a sheet comprising the oxygen barrier multilayer structure is vacuum or air-pressure formed.
